(19) United States
(12) Patent Application Publication
(10) Pub. No.: US 2016/0044451 A1
(43) Pub. Date: Feb. 11, 2016

(54) EVENT TETHER

(71) Applicant: Del Marth LLC, Rocklin, CA (US)

(72) Inventor: Ehrien Marth, Rocklin, CA (US)

(21) Appl. No.: 14/735,047

(22) Filed: Jun. 9, 2015

Related U.S. Application Data
(60) Provisional application No. 62/033,308, filed on Aug. 5, 2014.

(51) Int. Cl. H04W 4/02

(52) U.S. Cl. CPC H04W 4/02

(57) ABSTRACT

A computing device can be configured to monitor the estimated distance of a target computing device and alert a user when the estimated distance has exceeded a threshold distance. The computing device can provide the user with several options in response to an alert message, such as ignoring the alert message, extending the threshold distance, presenting an estimated location of the target computing device, triggering an alert message on the target computing device, etc. Further, a user can select a set of alert conditions for a target computing device that, when satisfied, result in the computing device presenting the user with an alert message. The set of alert conditions can include a threshold distance, time conditions, geographic location conditions, etc., that must be satisfied for the user to be alerted.

### CROSS REFERENCE

This application claims the benefit of U.S. provisional application No. 62/033,308, filed on Aug. 5, 2014, which is expressly incorporated by reference herein in its entirety.

### TECHNICAL FIELD

The present technology pertains to managing wireless tracking devices, and more specifically pertains to scheduling and managing alerts associated with wireless tracking devices.

### BACKGROUND

Current computing devices can include functionality to communicate with each other via wireless communication signals. For example, many computing devices are enabled to send and receive wireless communication signals using wireless technology standards such as Bluetooth®. Wireless communication signals sent between computing devices can include data identifying the transmitting computing device, such as a unique device identifier assigned to the transmitting computing device, as well as other desired data for transfer, such as data defining specific commands, streamed content, etc.

In addition to transmitting data between computing devices, wireless communication signals can also be used to determine the geographic distance between computing devices. For example, a received signal strength indicating a measurement of the power present in a wireless communication signal received by a receiving computing device can be used to estimate the distance between the receiving computing device and a transmitting computing device that transmitted the wireless communication signal. A weak received signal strength can indicate a relatively longer geographic distance between the transmitting and receiving computing devices, whereas a strong received signal strength can indicate a relatively shorter geographic distance between the transmitting and receiving computing devices.

Current technologies utilize signal strength to help users track and/or locate a target computing device. For example, a receiving computing device can present a user with an estimated distance of a target computing device from the receiving computing device based on the signal strength value of a wireless communication signal received from the target computing device. A user can thus easily determine the distance between the user and the target computing device and even use the estimated distance to track the location of the target computing device.

While these types of technologies enable a user to track the location of a target computing device, they also require a user to continuously check the estimated distance of the wireless tracking device. Further, these technologies are only useful after a user identifies a need to track the location of a target computing device. While this provides value to the user, in many cases it provides a solution to a problem (e.g., locating a lost or forgotten item) rather than preempting the problem (e.g., ensuring that the user does not lose or forget an item). Accordingly, improvements are needed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by practice of the principles set forth herein.

Disclosed are systems, methods, and non-transitory computer-readable storage media for scheduling and managing alerts associated with wireless tracking devices. A computing device can determine an estimated distance of a target computing device from the computing device based on wireless communication signals received from the target computing device. For example, a signal strength value indicating a measurement of the power present in a wireless communication signal received by a receiving computing device can be used to estimate the distance between the receiving computing device and a transmitting computing device that transmitted the wireless communication signal.

A computing device can be configured to monitor the estimated distance of a target computing device and alert a user when the estimated distance has exceeded a threshold distance. For example, the computing device can present the user with an alert message indicating that the distance between the computing device and the target computing device has exceeded the threshold distance. The computing device can provide the user with several options in response to an alert message, such as ignoring the alert message, extending the threshold distance, presenting an estimated location of the target computing device, triggering an alert message on the target computing device, etc.

The computing device can enable the user to select a set of alert conditions for a target computing device. The set of alert conditions can include one or more conditions that, when satisfied, result in the computing device presenting the user with an alert message. The set of alert conditions can include a threshold distance that, if exceeded, results in the computing device presenting the user with an alert message. Further, the alert conditions can include other conditions, such as time conditions, geographic location conditions, etc., that must be satisfied for the user to be alerted.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 an embodiment of a client device configured to track wireless communication devices and provide alert messages to users;

FIG. 3 shows a method of a client device 105ᵢ presenting a user with an alert message;

FIG. 4 shows a method of a tracking management system transmitting an alert message to a secondary client device;

FIGS. 5A-5C show screenshots of a tracking device management interface for adding a wireless tracking device to a user account;

FIGS. 6A-6E show screenshots of setting a set of alert conditions for a wireless tracking device;

FIGS. 7A-7C show screenshots of alert messages;

FIGS. 8A and 8B illustrate a wireless tracking device;

FIGS. 9A and 9B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for scheduling and managing alerts associated with wireless tracking devices. A computing device can determine an estimated distance of a target computing device from the computing device based on wireless communication signals received from the target computing device. For example, a signal strength value indicating a measurement of the power present in a wireless communication signal received by a receiving computing device can be used to estimate the distance between the receiving computing device and a transmitting computing device that transmitted the wireless communication signal.

A computing device can be configured to monitor the estimated distance of a target computing device and alert a user when the estimated distance has exceeded a threshold distance. For example, the computing device can present the user with an alert message indicating that the distance between the computing device and the target computing device has exceeded the threshold distance. The computing device can provide the user with several options in response to an alert message, such as ignoring the alert message, extending the threshold distance, presenting an estimated location of the target computing device, triggering an alert message on the target computing device, etc.

The computing device can enable the user to select a set of alert conditions for a target computing device. The set of alert conditions can include one or more conditions that, when satisfied, result in the computing device presenting the user with an alert message. The set of alert conditions can include a threshold distance that, if exceeded, results in the computing device presenting the user with an alert message. Further, the alert conditions can include other conditions, such as time conditions, geographic location conditions, etc., that must be satisfied for the user to be alerted.

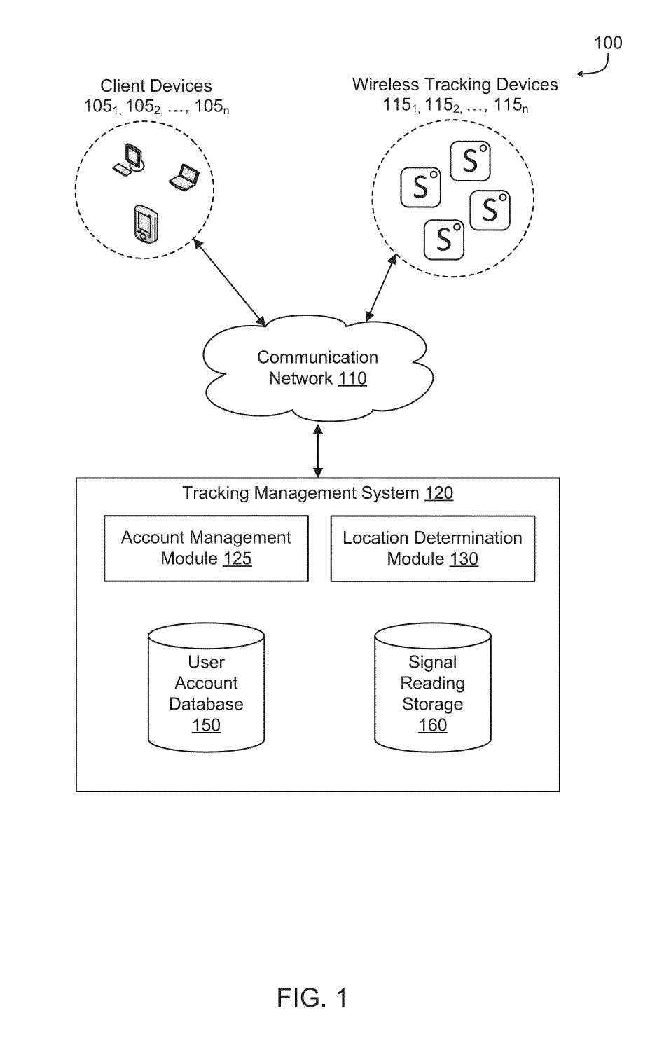

FIG. 1 illustrates an exemplary system configuration 100, wherein electronic devices communicate via a network and/or directly via wireless communication for purposes of exchanging content and other data. As illustrated, multiple computing devices can be connected to communication network 110 and be configured to communicate with each other through use of communication network 110.

Communication network 110 can be any type of network, including a local area network (“LAN”), such as an intranet, a wide area network (“WAN”), such as the internet, or any combination thereof. Further, communication network 110 can be a public network, a private network, or a combination thereof. Communication network 110 can also be implemented using any number of communication links associated with one or more service providers, including one or more wired communication links, one or more wireless communication links, or any combination thereof. Additionally, communication network 110 can be configured to support the transmission of data formatted using any number of protocols. Additionally, the computing devices can also communicate with each other directly via wireless communication signals using wireless technology standards such as Bluetooth®.

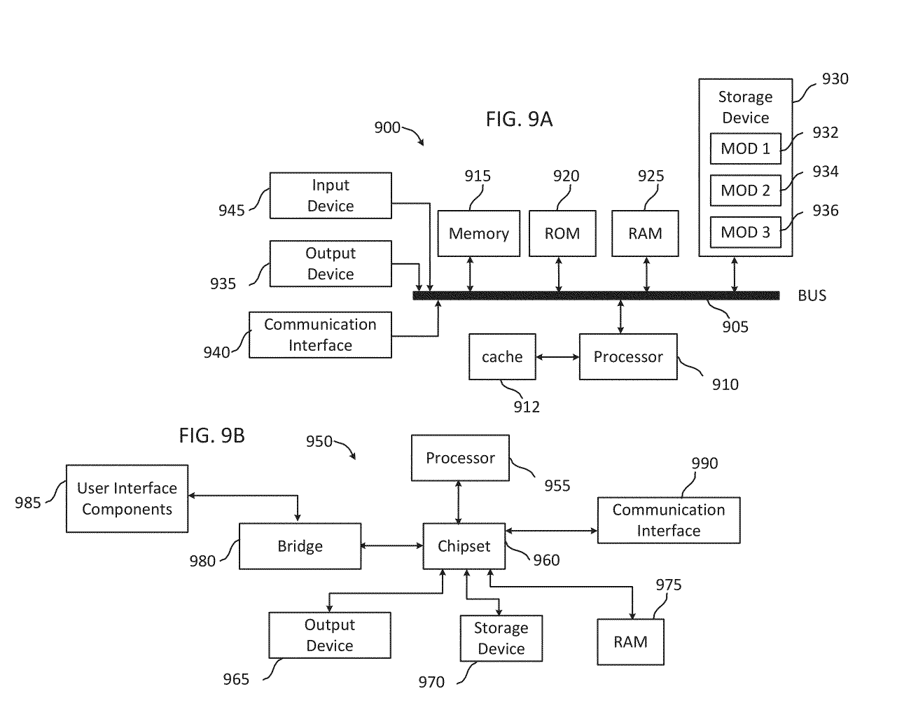

A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 900 of FIGS. 9A and 9B.

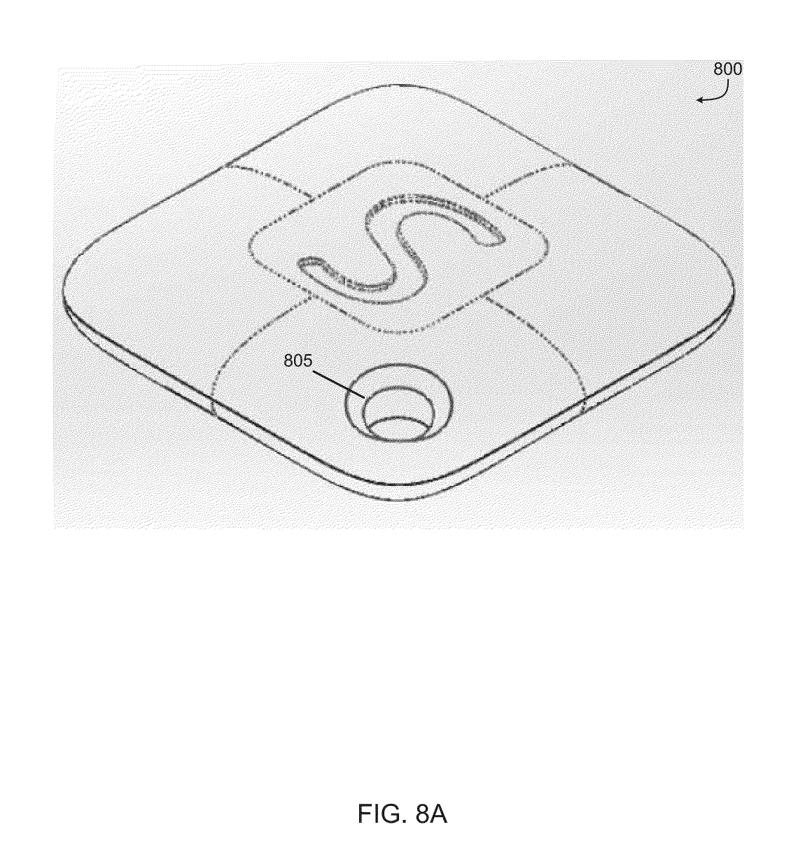

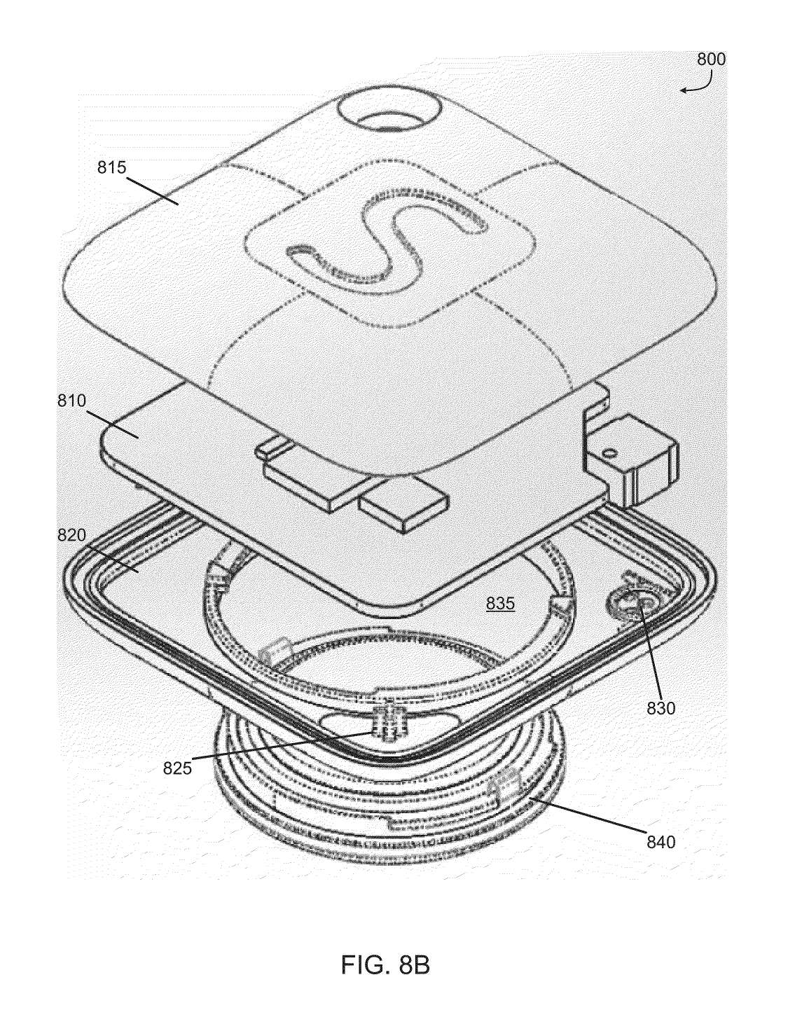

A computing device can also be a wireless tracking device configured primarily to send and receive wireless communication signals with other computing devices. For example, a computing device can be a Bluetooth® tracking device, such as wireless tracking device 800 of FIGS. 8A and 8B.

To facilitate communication with other computing devices, a computing device can also include a communication interface configured to receive a communication, such as a request, data, etc., from another computing device in network and/or direct wireless communication with the computing device and pass the communication along to an appropriate module running on the computing device. The communication interface can also be configured to send a communication to another computing device in network and/or direct wireless communication with the computing device.

In system 100, a user can track the location of one or more of wireless tracking devices 115₁, 115₂, . . . , 115ₙ (collectively “115”) through use of client devices 105₁, 105₂, . . . , 105ₙ (collectively “115”) and/or tracking management system 120.

A wireless tracking device 115ᵢ can be any type of computing device configured to communicate with another computing device by transmitting and receiving wireless communication signals. For example, a wireless tracking device 115ᵢ can be a Bluetooth® tracking device configured primarily to transmit and receive wireless communication signals using the Bluetooth® wireless technology standard.

While a wireless tracking device can be any type of computing device capable of communicating with another computing device by transmitting and receiving wireless communication signals, a wireless tracking device 115ᵢ can also be a computing device designed with the primary intent of being attached to items for tracking purposes. Accordingly, a wireless tracking device 115ᵢ can be designed to be relatively small in size so that it can be easily attached to items, such as keys, wallets, remote controls, children, etc. To provide a reduced size, a wireless tracking device 115ᵢ can be designed to include fewer and smaller components than traditional computing devices. For example, a wireless tracking device 115ᵢ can be designed to exclude many or all components that are not necessary to facilitate the desired functionality of the wireless tracking device 115ᵢ (e.g., using wireless communication signals to communicate with other computing devices).

A client device 105ᵢ can by any type of computing device configured to transmit and receive wireless communication signals, such as desktop computers; mobile computers; mobile communications devices (e.g. mobile phones, smart phones, tablets, etc.); smart televisions; set-top boxes, etc. Client devices 105 can be of varying type, capabilities, operating systems, etc.

Client devices 105 can be configured to communicate with one or more of wireless tracking devices 115 via wireless communication. For example, a user can pair a client device 105ᵢ to one or more of wireless tracking devices 115 to receive wireless communication signals from the paired wireless tracking devices 115. Alternatively, a client device 105ᵢ can receive wireless communication signals from all wireless tracking devices 115 within range of client device 105ᵢ. Likewise, a client device 105ᵢ can transmit wireless communication signals to one or more of wireless tracking devices 115.

A wireless communication signal can be a signal transmitted from one computing device that can be received by another computing device. For example, a wireless communication signal can be a wireless signal transmitted from an antenna of a transmitting computing device which can be received by an antenna of a receiving computing device that is within range to receive the wireless communication signal.

A wireless communication signal can be a signal sent using a wireless technology standard such as Bluetooth®. Further, a wireless communication signal can include metadata identifying the transmitting computing device. For example, a wireless communication signal can include a unique device identifier that identifies the transmitting computing device.

In some embodiments, wireless tracking devices 115 can be configured to continuously or repeatedly transmit or broadcast wireless communication signals which can be received by client devices 105 within range to receive the wireless communication signal. Further, client devices 105 can transmit a wireless communication signal to a wireless tracking device 115ᵢ prompting the wireless tracking device 115ᵢ to transmit a response wireless communication signal.

Client devices 105 can be configured to determine an estimated distance of a wireless tracking 115ᵢ based on a wireless communication signal received from the wireless tracking device 115ᵢ. An estimated distance of a wireless tracking device 115ᵢ can indicate an estimated distance of the wireless tracking device from the client device 105ᵢ that received the wireless communication signal. A client device 105ᵢ can determine the estimated distance of a wireless tracking device 115ᵢ based on a signal strength value of a wireless communication signal received from the wireless tracking device 115ᵢ.

Client devices 105 can be configured to track the location of one or more of wireless tracking devices 115 and provide alert messages to a user based on a set of alert conditions associated with the wireless tracking device 105ᵢ. A set of alert conditions can include one or more conditions that, if satisfied, result in a user receiving an alert message. For example, the set of alert conditions can dictate a threshold distance that, if exceeded, results in the user being alerted. Additionally, the set of alert conditions can dictate time conditions, geographic location conditions, etc., that must be satisfied.

Upon a determination that a set of alert conditions associated with a wireless tracking device 115ᵢ have been satisfied, a client device 105ᵢ can present the user with an alert message. An alert message can be an alert notifying the user that the set of alert conditions has been satisfied (e.g., notify the user that the estimated distance of a wireless tracking device 115ᵢ exceeds the threshold distance). A client device 105ᵢ can present the alert message to a user of the client device 105ᵢ, and/or transmit a message to tracking management system 120 to have an alert message presented on one or more other client devices 105.

Tracking management system 120 can be a system comprising of one or more computing devices that are configured to manage wireless tracking devices 115 for multiple user accounts. Tracking management system 120 can support connections from a variety of different types of client devices 105, such as desktop computers; mobile computers; mobile communications devices (e.g. mobile phones, smart phones, tablets, etc.); smart televisions; set-top boxes; and/or any other network enabled computing devices. For example, tracking management system 120 can be accessible to a client device 105ᵢ connected to communication network 110 by direct and/or indirect communication. Furthermore, tracking management system 120 can concurrently accept connections from and interact with multiple client devices 105.

To facilitate the various tracking management services, a user can create a user account with tracking management system 120. The account information for each created user account can be maintained in user account storage 150. User account storage 150 can store account information for each user account, including a unique account identifier identifying the user account, personal information, username, password, email address, home address, credit card information, banking information, etc. Account information can also include tracking management information, such as device identifiers identifying client device 105 and wireless tracking devices 115 associated with the user account, security settings, personal configuration settings, etc.

Tracking management system 120 can include account management module 125 configured to manage each user account. For example, account management module 125 can be configured to enable users to create a user account with tracking management system 120, as well as add tracking devices 115 and/or client devices to the user's account. To add a tracking device 115ᵢ and/or client device 105ᵢ to a user's account, tracking management module 120 can communicate with user account database 150 to access the user's account and add a device identifier for the added tracking device 115ᵢ and/or client device 105ᵢ.

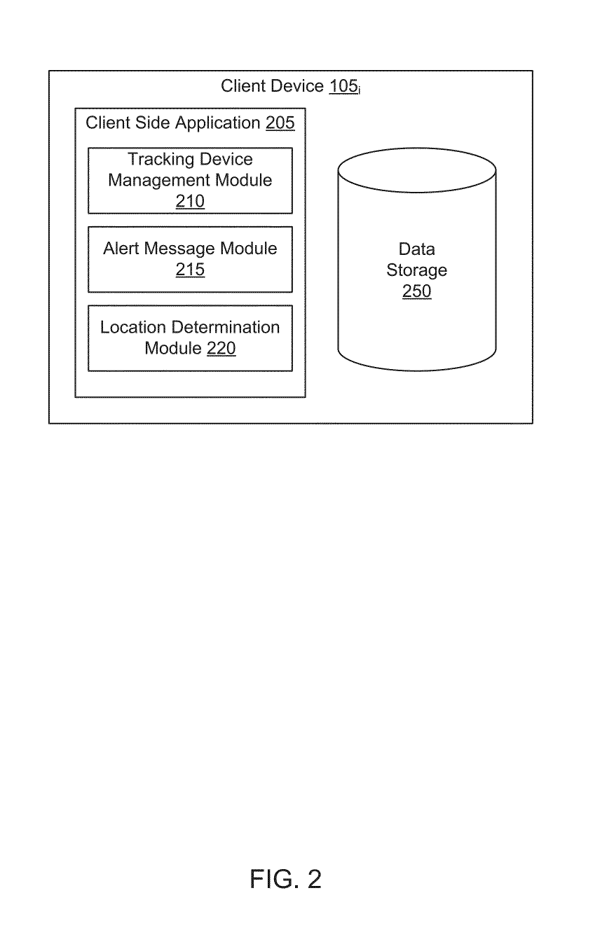

FIG. 2 shows an embodiment of a client device configured to track wireless communication devices and provide alert messages to users. FIG. 2 is described in view of the system shown in FIG. 1. As shown, client side application 205 can be installed on client device 105ᵢ. Client side application 205 can be an application configured to enable client device 105ᵢ to track one or more wireless tracking devices 115 and manage alert messages for the wireless tracking devices 115. Client side application 205 can be a tracking specific application, such as a stand-alone application, one or more application plug-ins, and/or a browser extension configured to track wireless communication devices 115. Client side application 205 can also be a third-party application, such as a web browser, that resides on client device 115ᵢ and is configured to communicate with tracking management system 120. In either case, client-side application 205 can present a user interface (UI) for the user to track the location of one or more wireless communication devices 115. Further, client device 105ᵢ can include data storage 250 configured to maintain data utilized by client side application 205.

Client side application 205 can include tracking device management module 210 configured to enable a user to manage one or more wireless tracking devices 115ᵢ. For example, tracking device management module 210 can present a user with a tracking device management interface that enables a user to perform multiple functions, such as adding and removing wireless tracking devices 115 and/or client device 105 to the user's account, modify settings, etc.

In some embodiments, tracking device management module 210 can enable a user to add wireless tracking devices 115 to the user's account. Wireless tracking devices 115 added to the user's account can be tracked for the user. This can include, receiving wireless communication signals transmitted by the added wireless tracking devices 115 and determining an estimated distance of the added wireless tracking devices 115.

To enable a user to add a wireless tracking device 105ᵢ to the user's account, tracking device management module 210 can present the user with data identifying wireless tracking devices 115 that are detected by client device 105ᵢ and that are eligible to be tracked. For example, tracking device management module 210 can retrieve device identifiers from wireless communication signals received by client device 105ᵢ and present the wireless identifiers to the user. Tracking device management module 210 can also present the user with user interface elements, such as buttons, enabling the user to select to add one or more of the presented wireless communication devices 105 to the user's account.

In some embodiments, tracking device management module 210 can present all detected wireless tracking devices 105 as being eligible to be added to the user's account. Alternatively, in some embodiments, tracking device management module 210 can present only wireless tracking devices 115 transmitting a wireless communication signal indicating that the wireless tracking device 115ᵢ is eligible to be added to the user's account. For example, a wireless tracking device 105ᵢ can include an input device, such as a physical button, nob, lever, etc., that, when actuated, causes the wireless tracking device 115ᵢ to transmit a wireless communication signal indicating that the wireless tracking device 115ᵢ is eligible to be added to the user's account.

In some embodiments, tracking device management module 210 can present only wireless tracking devices 115 within a specified distance of client device 105ᵢ. Tracking device selection module 210 can determine the distance of a wireless tracking device 115ᵢ based on the signal strength value of a wireless communication signal received from the wireless tracking device 115ᵢ.

Upon receiving a user input selecting one or more of the available wireless tracking devices, tracking device management module 210 can add the identified wireless tracking devices 115 to the user's account. For example, tracking device management module 210 can provide the device identifier to tracking management system 120 to be added to the user's account. Further, tracking device management module 210 can record the device identifier of the selected wireless tracking device in data storage 250, thereby indicating that the corresponding wireless tracking device 115ᵢ has been added to the user's account.

Client-side application 205 can further include alert message module 215 configured to enable a user to set alert conditions for one or more of the wireless tracking devices 115 added to the user's account, as well as provide alert messages to the user when the set of alert conditions have been satisfied. For example, alert message module 215 can present the user with an alert message interface that presents the user with data identifying the wireless tracking devices 115 added to the user's account, as well as enables the user to select a set of alert conditions for the presented wireless tracking devices 115.

A set of alert conditions can include one or more conditions that, if satisfied, result in a user receiving an alert message. For example, a set of alert conditions can include a threshold distance that, if exceeded, results in the user receiving an alert message. For instance, a parent may wish to track the location of the parent's child and receive an alert message if the child strays beyond a specified distance away from the parent. Accordingly, the parent can attach/provide a wireless tracking device 115ᵢ to the child and select a set of alert conditions that includes a threshold distance that, if exceeded, results in the parent receiving an alert message.

In addition to a threshold distance, a set of alert conditions can include one or more other conditions that must be satisfied. For example, a set of alert conditions can include a time range during which a user would like to receive and/or not receive alert messages. A time range can be a period of time spanning from a starting time to an ending time. A time range can be within a single day and/or span multiple days. The time range can be set as a one-time event and/or a recurring event. For example, a user can set a single time range during which the user would like to receive alert messages (e.g., today from 12 pm-4 pm) or, alternatively, a recurring time range during which the user would like to receive alert messages (e.g., every Monday from 8 am-10 am).

A user can use the time range to set times during which the user would like to receive alert messages regarding a specific wireless tracking device 115ᵢ. For example, a user that wants to be sure to have their wallet when leaving the house in the morning for work can attach a wireless tracking device 115ᵢ to their wallet and select a set of alert conditions that includes a threshold distance and time range during which the user generally leaves the house for work (e.g., Monday-Friday from 7 am-8 am). If the distance between the user's client device 105 and the wireless tracking device exceeds the threshold distance during the time range (e.g., Monday-Friday from 7 am-8 am), the user will receive an alert message. The user will not, however, receive an alert message if the distance between the user's client device 105 and the wireless tracking device exceeds the threshold distance during a time outside of the specified time range (e.g., anytime Saturday, Monday at 9 am, etc.).

The set of alert conditions can further include a time range during which a user would like to not receive alert messages. For example, a user may choose to not receive alert messages during a time range when the user is generally asleep (e.g., Everyday from 11 pm-7 am). Alternatively, a user may choose to not receive alert messages during a time when the user will be at one location, such as during work hours.

The set of alert conditions for a wireless tracking device 115ᵢ can include multiple time ranges. For example, a user can establish a time range for when the user generally leaves the house to go to work and another time range for when the user generally leaves the office to go home. Further, the various time ranges can each be associated with a different threshold distance. For example, a user can establish a shorter threshold distance when leaving the house and a longer threshold distance when leaving work.

The set of alert conditions can also include one or more conditions based on geographic location. The geographic location can include geographic coordinates identifying the geographic location as well as a predetermined distance from the geographic location. A user that wishes to always be sure to have his/her wallet when the user leaves his/her home can attach a wireless tracking device 115ᵢ to the wallet and set a set of alert conditions that includes a threshold distance, the geographic location of the user's home and a predetermined distance from the user's home. As a result, the user will receive an alert message if the distance between the user's client device 105ᵢ and the wireless tracking device 115ᵢ exceeds the threshold distance while the client device 105ᵢ and/or the wireless tracking device 115ᵢ are located at a geographic location within the predetermined distance of the user's home.

In some embodiments, the predetermined distance can be set by a user. For example, alert message module 215 can enable a user to set the predetermined distance for each geographic location. Alternatively, the predetermined distance can be a standard predetermined distance set by alert message module 215. For example, alert message module 215 can enable a user to select a geographic location and alert message module 215 will assign the standard predetermined distance to the geographic location. Alert message module 215 can store the geographic coordinates for the specified location, as well as the predetermined distance, in data storage 250.

In some embodiments, alert message module 215 can enable a user to select a type of geographic location rather than a specific geographic location. For example, a user may wish to be sure to always have his/her wallet when leaving certain types of geographic locations such as a restaurant, grocery store, shopping mall, etc. A user can select the type of geographic location as well as a predetermined distance. Thus, the user can receive an alert message if the distance between the user's client device 105ᵢ and the wireless tracking device 115ᵢ exceeds the threshold distance while the client device 105ᵢ and/or the wireless tracking device 115ᵢ are located at a geographic location within the predetermined distance of a geographic location of the selected type (e.g., within a predetermined distance of a grocery store, restaurant, etc.).

Alert message module 215 can record the set of alert conditions for a wireless tracking device 115ᵢ in data storage 250 and associate the set of alert conditions with the wireless tracking device 115ᵢ. For example, alert message module 215 can tag, label and/or otherwise identify the set of alert conditions with a device identifier for the corresponding wireless tracking device 115ᵢ. The set of alert conditions stored in data storage 250 can include data identifying the selections made by the user. For example, the set of alert conditions can include data identifying threshold distances, a start time and end time of a time period, whether the specified time period is one time or recurring, whether the user would like to receive or not receive alert messages during the time period, geographic coordinates identifying geographic locations selected by a user, predetermined distances associated with the geographic locations, etc.

Once stored, alert message module 215 can use the set of alert conditions to determine whether a user should be provided with an alert message. For example, to determine whether the distance between the client device 105ᵢ and a wireless tracking device 115ᵢ exceeds a threshold distance, alert message module 215 can determine an estimated distance of the wireless tracking device 115ᵢ from the client device 105ᵢ. Alert message module 215 can determine the estimated distance based on a signal strength value of a wireless communication signal received by the client device 105ᵢ from the wireless tracking device 115ᵢ. A signal strength value can be a measure of the amount of power present in the wireless communication signal when the wireless communication signal was received by the client device 105ᵢ from the wireless tracking device 115ᵢ. Alert message module 215 can compare the determined estimated distance of the wireless tracking device 115ᵢ to the threshold distance specified by the set of alert conditions to determine whether the distance between the wireless tracking device 115ᵢ and the client device 105ᵢ exceeds the threshold distance.

To determine whether a time based condition has been satisfied, alert message module 215 can determine a current time. For example, alert message module 215 can gather the current time from an internal clock of client device 115ᵢ. The current time can include the time of day as well as the date. Alert message module 215 can compare the current time to a start and end time of a time period included in a set of alert conditions to determine whether the current time is within the specified time period.

To determine whether a geographic location condition has been satisfied, alert message module 215 can determine a current geographic location of the client device 105ᵢ. Alert message module 215 can determined the current location of the client device 105ᵢ based on data gathered from a Global Positioning System (GPS) component of the client device. The data gathered form the GPS component can include geographic coordinates identifying the current location of the client device 115ᵢ. Alert message module 215 can use the current location of the client device 115ᵢ, the geographic coordinates included in the set of alert conditions and the predetermined distance included in the set of alert conditions, to determine whether the current location of the client device 105ᵢ is within the predetermined distance of the geographic location specified by the set of alert conditions.

To determine whether the client device 105ᵢ is within predetermined distance of a type of geographic location (e.g., restaurant, grocery store, etc.,), alert message module 215 can gather map data describing locations within the predetermined distance of the current location of client device 105ᵢ. For example, client device 105ᵢ may have map data available in local memory, such as data storage 250 and alert message module 215 can gather the map data from data storage 250. Alternatively, alert message module 215 can gather the map data from a third party server (not shown) that provides map data and is in network connection with client device 105ᵢ.

If alert message module 215 determines that a set of alert conditions associated with a wireless tracking device 115ᵢ are satisfied, alert message module 215 can provide the user with an alert message. An alert message can be a message alerting the user that the distance between the client device 105ᵢ and the wireless tracking device 115ᵢ has exceeded the threshold value. For example, an alert message can present the user with data identifying the wireless tracking device 115ᵢ, such as the device identifier or a name provided by the user for the wireless tracking device 115ᵢ. The user may provide a name for a wireless tracking device 115ᵢ to identify the wireless tracking device 115ᵢ and/or an item that the wireless tracking device 115ᵢ is attached to for tracking purposes.

Alert message module 215 can present the alert message to the user as a notification on client device 105ᵢ. For example, a notification can be presented on a screen of client device 105ᵢ. Further, alert message module 215 can cause the alert message to be presented on a secondary device of the user, such as a smart watch in connection with client device 105ᵢ. Alert message module 215 can further cause client device 105ᵢ to perform an audio or other alert, such as playing a tone, causing client device 105ᵢ to vibrate, etc.

In some embodiments, alert message module 215 can present an alert message using contact information provided by the user. For example, alert message module 215 can send an e-mail, instant message, etc., using contact information provided by the user and stored in data storage 250. This can include contact information of the user and/or contact information for another user, such as another parent, grandparent, etc.

In addition to alerting the user that the distance of a wireless tracking device 115ᵢ has exceeded the threshold distance, in some embodiments, the alert message can also enable the user to select one or more responses. For example, the alert message can include user interface elements, such as buttons, links, etc., which the user can actuate to select a response corresponding to the actuated user interface element.

In some embodiments, the alert message can enable the user to select to ignore the alert message. Ignoring the alert message can cause the alert message to be removed from client device 105ᵢ. For example, upon receiving a user input indicating that a user would like to ignore an alert message, alert message module 215 can cause the alert message to be removed.

Further, upon receiving a user input indicating that a user would like to ignore an alert message, alert message module 215 can withhold presenting new alert messages regarding the wireless tracking device 115ᵢ indefinitely and/or for a specified period of time. Thus, alert message module 215 will not present the user with an alert message regarding the wireless tracking device 115ᵢ during the specified time, even if a set of alert conditions associated with the wireless tracking device 115ᵢ are satisfied.

In some embodiments, the alert message can be configured to enable the user to select a specified period of time during which the user would like to withhold receiving alert messages regarding the wireless tracking device 115ᵢ. Alternatively, the specified period of time can be a standard length of time used each time a user selects to ignore an alert message.

In some embodiments, an alert message can enable a user to select to increase the threshold distance for the wireless tracking device 115ᵢ. For example, the alert message can enable the user to select an updated threshold distance or a distance by which to increment the threshold distance. Alternatively, the threshold distance can be incremented by a standard distance. Upon receiving a user input indicating that a user would like to increase the threshold distance, alert message module 215 can modify the set of alert conditions associated with the wireless tracking device 115ᵢ to update the threshold distance.

In some embodiments, an alert message can enable a user to cause the wireless tracking device 115ᵢ to perform an audio sound. For example, the wireless tracking device 115ᵢ can include an audio output device such as a speaker. In response to receiving a user input indicating that a user would like to cause the wireless tracking device 115ᵢ to perform an audio sound, alert message module 215 can cause client device 105ᵢ to transmit a wireless communication signal to the wireless tracking device 115ᵢ including a command to perform the audio sound.

An audio sound can be any type of audio sound such a single beep, sequence of beeps, consistent sound, etc. In some embodiments, the command can cause the wireless tracking device 115ᵢ to perform the audio sound for a predetermined amount of time. Alternatively, in some embodiments, the command can cause the wireless tracking device 115ᵢ to perform the audio sound until the wireless tracking device 115ᵢ receives another command to stop the audio sound. In this type of embodiments, alert message module 215 can continue to track the estimated location of the wireless tracking device 115ᵢ and, upon a determination that the estimated distance of the wireless tracking device 115ᵢ does not exceed the threshold distance, send a wireless communication signal to the wireless tracking device 115ᵢ including a command to discontinue performance of the audio sound.

In some embodiments, an alert message can enable a user to view the location of the wireless tracking device 115ᵢ. For example, client side application 205 can include location determination module 220 configured to determine the estimated location of a wireless tracking device 115ᵢ and present the estimated location of the wireless tracking device 115ᵢ. For example, location determination module 220 can present the user with a location interface that presents the user with a map and identifies the estimated location of the wireless tracking device 115ᵢ on the map. Location determination module 220 can determine the estimated location of the wireless tracking device 115ᵢ using any known technique in the art, including triangulation. Upon receiving an input from a user to view the estimated location of the wireless tracking device 115ᵢ, location determination module 220 can determine the estimated location of the wireless tracking device 115ᵢ and present the estimated location to the user.

In addition to presenting an alert message on client device 105ᵢ, alert message module 215 can also provide alert messages to one or more secondary client devices 105 that are not within range to receive wireless communication signals from the wireless tracking device 115ᵢ. This can be useful in numerous scenarios. For example, a parent nearby his/her child may not notice an alert message indicating that the distance of a wireless tracking device 115ᵢ attached to the child has exceeded the threshold distance from the parent's client device 105ᵢ. In this type of situation, an alert message can also be sent to a secondary client device 105ᵢ of a second parent, even though the secondary client device 105ᵢ of the second parent is not within range to receive wireless communication signals from the wireless tracking device 115ᵢ.

As another example, a user leaving on vacation can attach a wireless tracking device 115ᵢ to an item that will remain at the user's home and track the location of the wireless tracking device 115ᵢ with a client device 105ᵢ that will remain within range to receive wireless communication signals from the wireless tracking device 115ᵢ. If somebody attempts to steal the item, the distance between the wireless tracking device 115ᵢ and the client device 105ᵢ will exceed the threshold distance and the user can then receive an alert message on a secondary client device 105ᵢ taken with the user on vacation.

To accomplish this, in some embodiments, client devices 105ᵢ can be configured to transmit an alert notification using contact information, such as an e-mail address, phone number, etc., provided by the user. Client device 105ᵢ can transmit the alert notification using the provided contact info, such as an e-mail, instant message, text message, etc.

In some embodiments, client devices 105ᵢ can utilize tracking management system 120 to transmit alert messages to secondary client devices 105. For example, a client device 105ᵢ can transmit a message to tracking management system 120 alerting tracking management system 120 that a set of alert conditions for a wireless tracking device 115ᵢ have been satisfied. Tracking management system 120 can then transmit an alert message to one or more secondary client devices 105 associated with the corresponding user's account. For example, a user can add multiple client devices 105 to their user account and/or link their user account to one or more other user accounts. The client devices 105 added to the user's account and/or added to user accounts linked to the user's account can be eligible as secondary client devices 105 that can receive an alert notification. Upon receiving a notification that a set of alert conditions have been met, tracking management system 120 can identify the secondary client devices 105 associated with the user's account and transmit an alert notification to one or more of the secondary client devices 105.

The alert message sent to a secondary client device 105ᵢ can alert the secondary client device 105ᵢ that the set of alert conditions have been satisfies and enable a receiving user to select to ignore the alert message, cause an audio sound, extend the threshold distance, etc. For example, the alert message can include one or more user interface elements that enables a user of a secondary client device 105ᵢ to select to ignore the alert message, cause an audio sound to be played by the wireless tracking device 115ᵢ, extend the threshold distance, etc. A secondary client device 105ᵢ can transmit the user's selection to wireless tracking system 120, which can then transmit the selection to client device 105ᵢ. Client device 105ᵢ can then perform the selected action.

In some embodiments, users can select settings regarding transmitting alert notifications to secondary client devices 105. For example, a user can select whether the user would like alert messages sent to secondary client devices 105, identify one or more secondary client device 105 to receive alert notifications, select times the secondary client devices can receive alert notifications, select wireless tracking devices 115 for which the secondary client devices 105 should receive alert notifications, select permission levels for the secondary client devices 105, etc.

In addition to transmitting alert messages to secondary client devices 105, in some embodiments, wireless tracking system 120 can enable secondary client devices 105 to remotely select a set of alert conditions for a wireless tracking device 115ᵢ. For example, a user that is away from the house may wish to set a set of alert conditions for a wireless tracking device 115ᵢ that is located at their house and within range of a client device 105ᵢ that can track the wireless tracking device 115ᵢ. The set of alert conditions set by the user can be transmitted to wireless tracking system 120, which then pushes the set of alert conditions to the corresponding client device 105ᵢ.

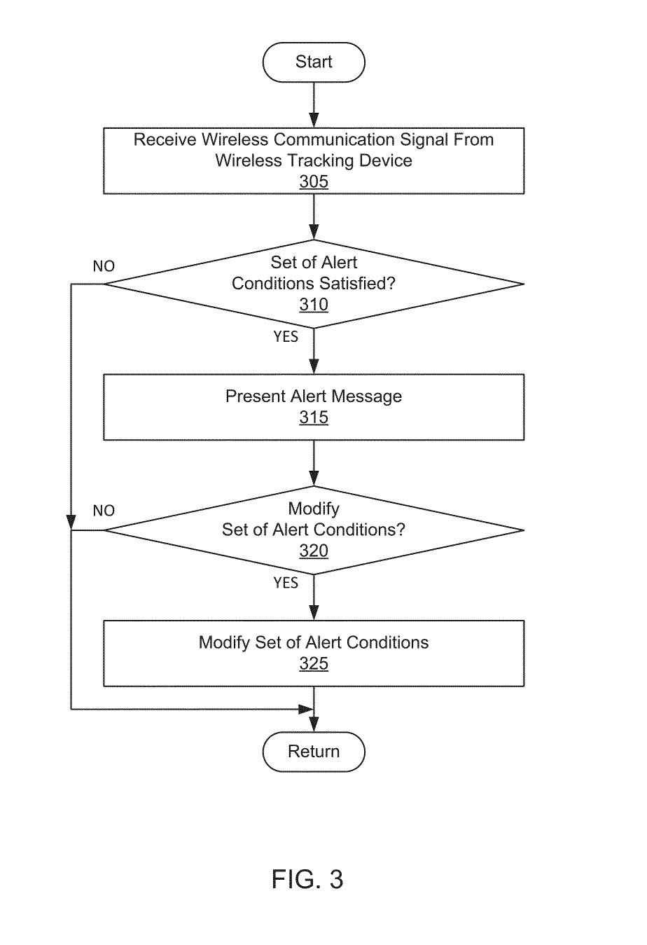

FIG. 3 shows a method of a client device 105ᵢ presenting a user with an alert message. The method shown in FIG. 3 is described in view of the systems shown in FIG. 1 and FIG. 2. Although specific steps are shown in FIG. 3, in other embodiments the method may have more or less steps. Further, the order in which the steps are performed is just one possible embodiment and is not meant to be limiting. The method may be performed in a variety of differing orders, including one or more steps being performed simultaneously, and/or including more or less steps than those shown in FIG. 3.

As shown, the method begins at block 305 where a client device 105ᵢ receives a wireless communication signal from a wireless tracking device 115ᵢ. For example, a user of the client device 105ᵢ may have attached the wireless tracking device 115ᵢ to an item that the user would like to track. The user may have further added the wireless tracking device 115ᵢ to their user account to be tracked for the user.

At block 310, the client device 105ᵢ can determine whether a set of alert conditions associated with the wireless tracking device 115ᵢ have been satisfied. The set of alert conditions can include one or more conditions set by the user of the client device 105ᵢ that, if satisfied, result in the user receiving an alert message regarding the wireless tracking device 115ᵢ. For example, the set of alert conditions can include a threshold distance, time based conditions, geographic conditions, etc., that, if met, result in the user receiving an alert notification.

If at block 310, the client device 105ᵢ determines that a set of alert conditions for the wireless tracking device 115ᵢ have been satisfied, the method continues to block 315 where the client device 105ᵢ presents the user with an alert message. The alert message can notify the user that the threshold distance has been exceeded as well as provide the user with one or more responses to choose from. For example, the alert message can enable the user to ignore the alert message or modify the set of alert conditions to extend the predetermined threshold.

At block 320, the client device 105ᵢ determines whether the user selected to modify the set of alert conditions. For example, the user may have selected to increase the predetermined threshold distance.

If at block 320, the client device 105ᵢ determines that user has selected to modify the set of alert conditions, the method continues to block 325 where the client device 105ᵢ modifies the set of alert conditions as specified by the user.

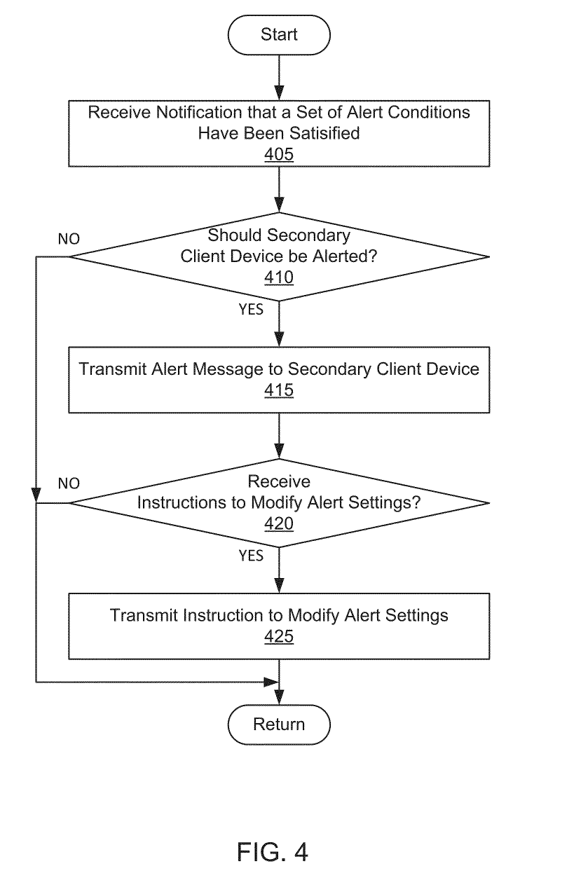

FIG. 4 shows a method of a tracking management system transmitting an alert message to a secondary client device. The method shown in FIG. 4 is described in view of the systems shown in FIG. 1 and FIG. 2. Although specific steps are shown in FIG. 4, in other embodiments the method may have more or less steps. Further, the order in which the steps are performed is just one possible embodiment and is not meant to be limiting. The method may be performed in a variety of differing orders, including one or more steps being performed simultaneously, and/or including more or less steps than those shown in FIG. 4.

At block 405, the tracking management system 120 receives a notification that a set of alert conditions have been satisfied. For example, the notification can be received from a client device 105ᵢ that is within range to receive wireless communication signals from a wireless tracking device 115ᵢ. The notification can be transmitted by the client device 105ᵢ in response to a determination by the client device 105ᵢ that a set of alert conditions associated with the wireless tracking device 115ᵢ have been satisfied.

At block 410, the tracking management system 120 determines whether a secondary client device 105ⱼ should be notified. For example, tracking management system 120 can identify a user account associated with the client device 105ᵢ and/or wireless tracking device 115ᵢ. The user account can maintain settings provided by the user associated with the user account. The settings can indicate whether and when the secondary client device 105ⱼ should be alerted as well as include data identifying the secondary client device 105ⱼ. The tracking management system 120 can determine whether the secondary client device 105ⱼ should be alerted based on the settings in the user account.

If at block 410, the tracking management system 120 determines that the secondary client device 105ⱼ should be notified, the method continues to block 420 where the tracking management system 120 transmits an alert message to the secondary client device 105ⱼ. The alert message can notify the user that the threshold distance has been exceeded as well as provide the user with one or more responses to choose from. For example, the alert message can enable the user to ignore the alert message or modify the set of alert conditions to extend the predetermined threshold.

At block 420, the tracking management system 120 determines whether instructions to modify the alert settings have been received from the secondary client device 105ⱼ. If instructions have been receive, at block 420, the tracking management system 120 can transmit instructions to the client device 105ᵢ to modify the alert settings accordingly.

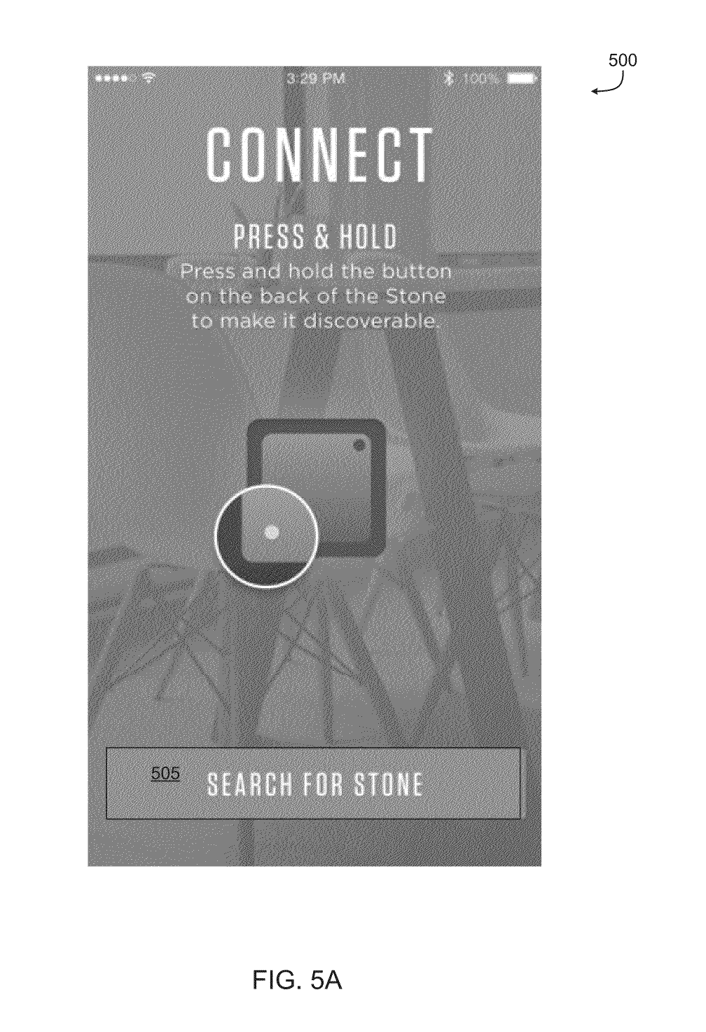

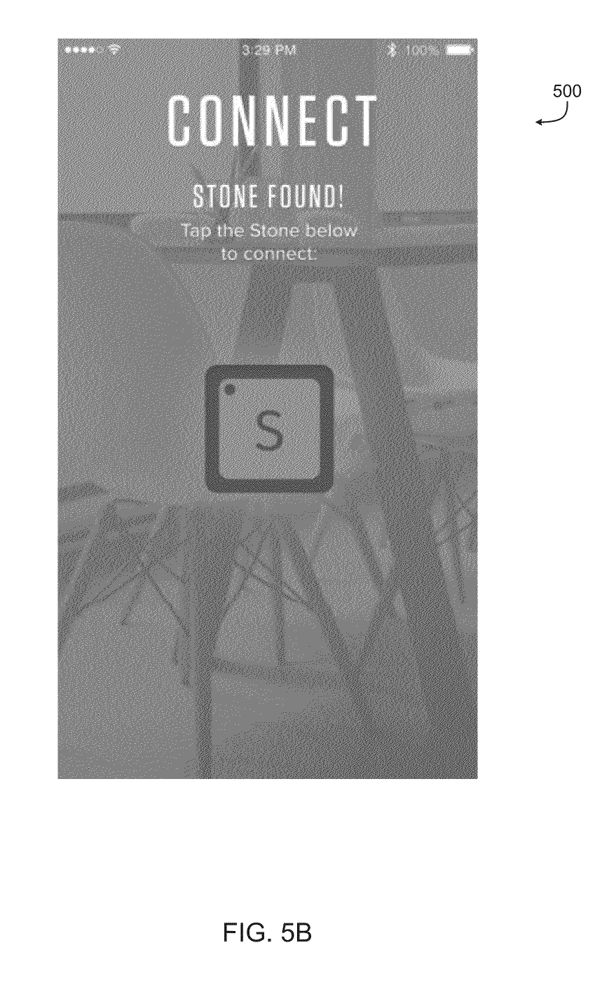

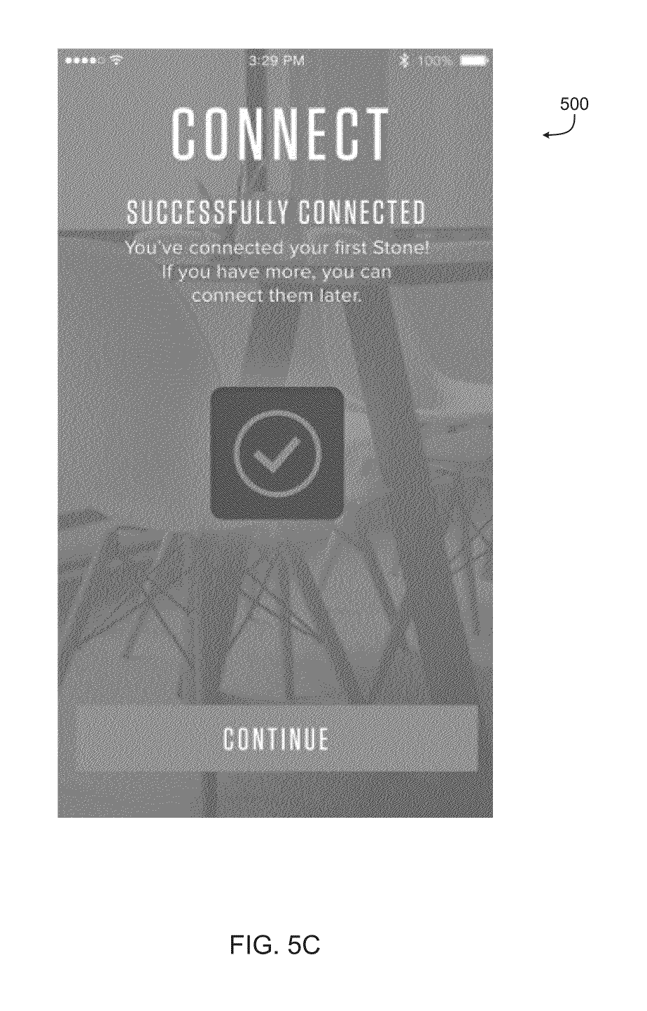

FIGS. 5A-5C show screenshots of a tracking device management interface for adding a wireless tracking device to a user account. As shown in FIG. 5A, the tracking device management interface 500 prompts a user to press and hold a button on a wireless tracking device to add the wireless tracking device to the user's account. Pressing the button can cause the wireless tracking device to transmit a wireless communication signal indicating that the wireless tracking device is eligible to be added to a user account. The tracking device management interface 500 can further include a user interface element 505 that, when selected, can cause the client device to search for eligible wireless tracking devices to add to the user's account. For example, a user can select user the user interface element after pressing the button on their wireless tracking device.

FIG. 5B shows the tracking device management interface 500 as a result of the user selecting user interface element 505. As shown, the tracking device management interface 500 indicates that the wireless tracking device has been detected. The detected wireless tracking device can then be added to the user's account.

FIG. 5C shows the tracking device management interface 500 after the wireless tracking device has been successfully added to the user's account. As shown, the user is presented with a message confirming that the wireless tracking device has been added to the user's account.

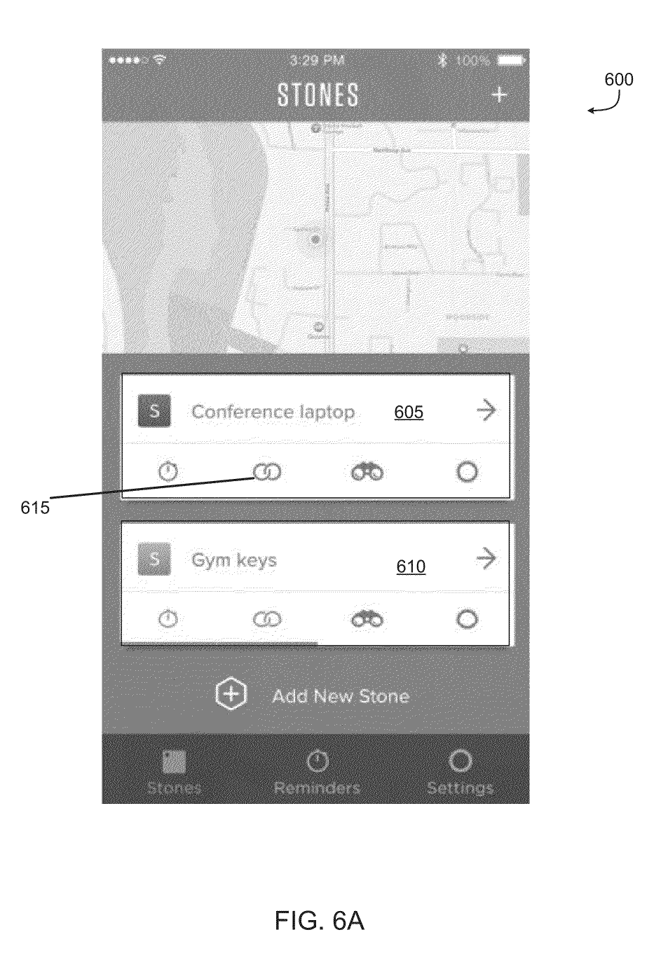

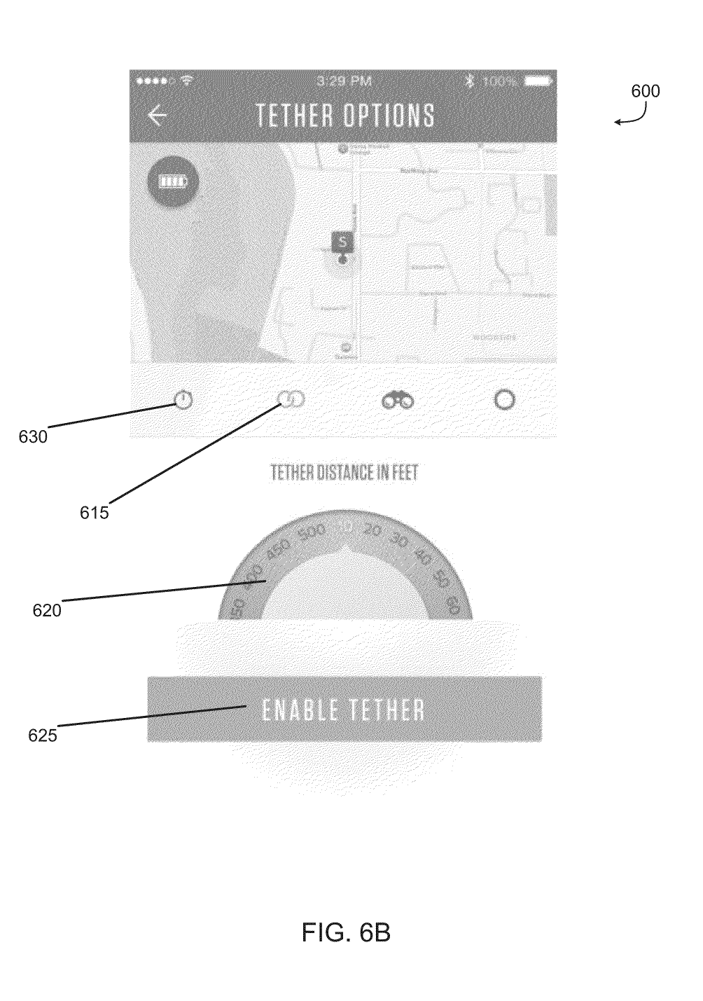

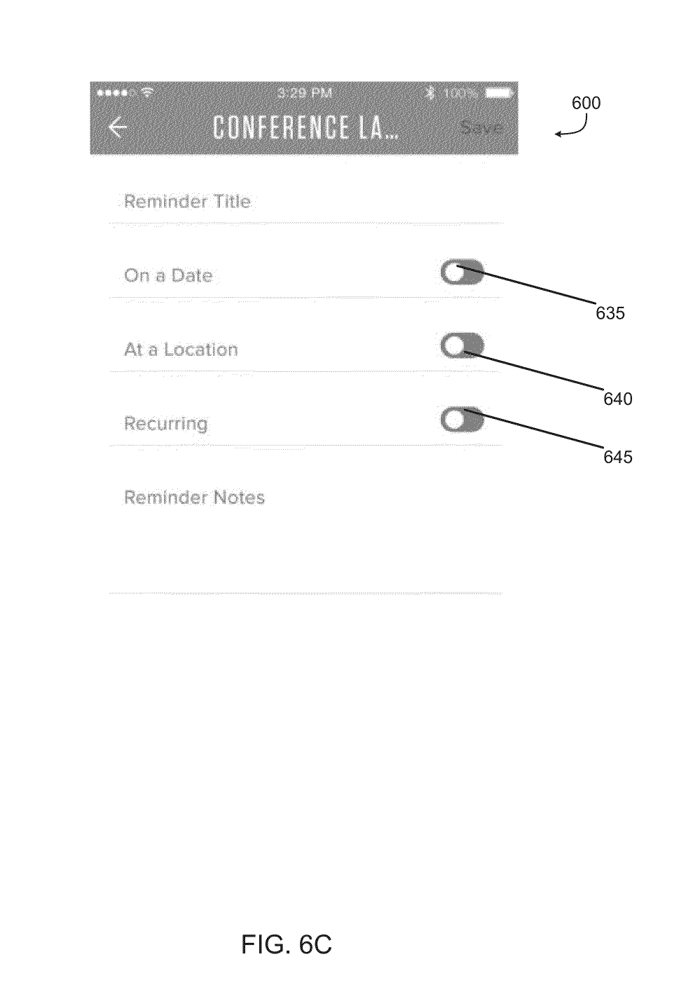

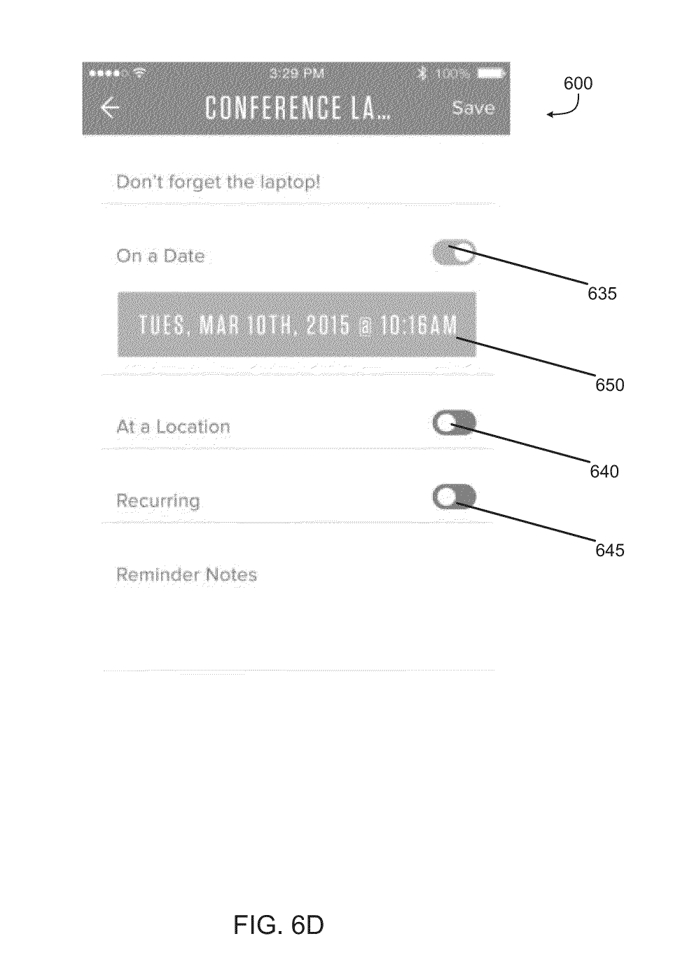

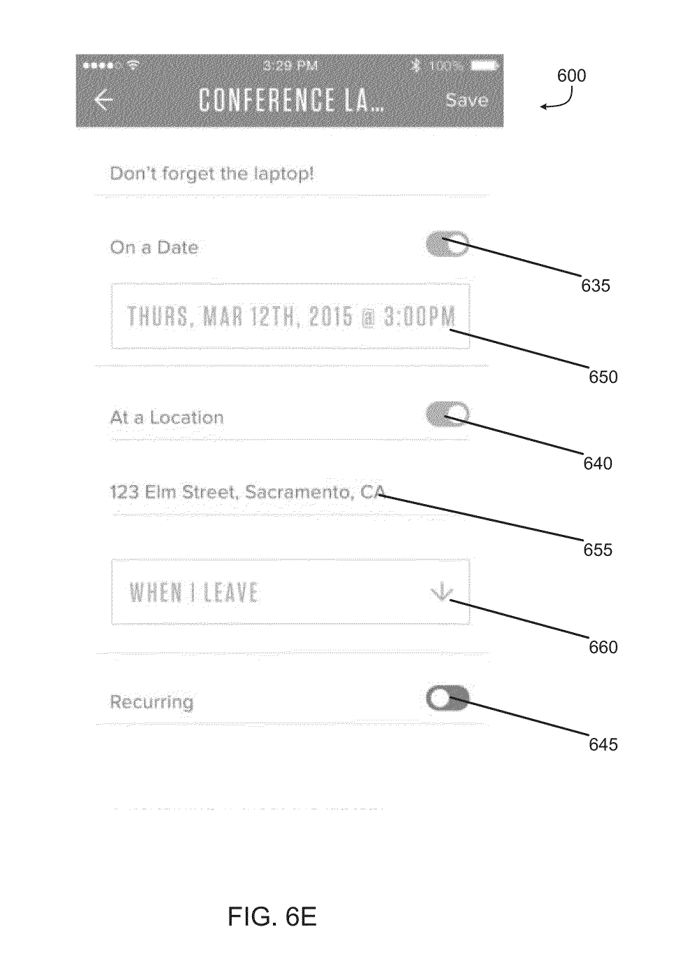

FIGS. 6A-6E show screenshots of setting a set of alert conditions for a wireless tracking device. As shown in FIG. 6A, alert message interface 600 can present the user with visual indicators of the wireless tracking devices added to the user's account. For example, alert message interface 600 includes visual indicator 605 and visual indicator 610, each representing a wireless tracking device assigned to the user's account. Further, visual indicator 605 and visual indicator 610 can be selectable to enable a user to select to set alert conditions for the corresponding wireless tracking device. For example, visual indicator 605 can include selectable element 615 that, when selected, enables the user to select to receive an alert message for the corresponding wireless tracking device.

FIG. 6B shows a screenshot of alert message interface 600 as a result of a user selecting selectable element 615. As shown, alert message interface 600 presents the user with adjustable element 620 that enables the user to set a threshold distance for the wireless tracking device. A user can adjust adjustable element 620 to set the desired threshold distance. Further, the user is presented with selectable element 625 that enables the user to select to receive alert messages. The user can select selectable element 625 to receive alert notifications when the set of alert conditions have been satisfied (e.g., the threshold distance has been exceeded). The user can thus use selectable element 625 to toggle between receiving and not receiving alert messages.

Alert message interface 600 further includes selectable element 630 that enables the user to select further conditions for receiving alert notifications. FIG. 6C shows a screenshot of alert message interface 600 as a result of a user selecting selectable element 630. As shown, the alert message interface 600 presents the user with selectable element 635 to select a time based conditions, selectable element 640 to select a location based condition and selectable element 645 to select to make the conditions recurring.

FIG. 6D show a screenshot of alert message interface 600 as a result of the user selecting selectable element 635. As shown, the user is presented with adjustable element 650 that enables the user to select a day and time condition that must be satisfied. Specifically, the user has selected Tuesday, March 10 at 10:16 am.

FIG. 6E shows a screenshot of alert message interface 600 as a result of the user selecting selectable element 640. As shown, the user is presented with adjustable element 655 where a user can select a geographic location. As shown, the user has selected a specified address. Further, the user is presented with adjustable element 660 to set an action associated with the geographic location. As shown, the user has selected to be alerted if the user leaves the specified geographic location. As a result, the user will receive an alert notification if he/she leaves the geographic location (123 Elm Street) at the specified time (Thursday, March 12 @ 3 pm) without the corresponding item (e.g., the item attached to the wireless tracking device).

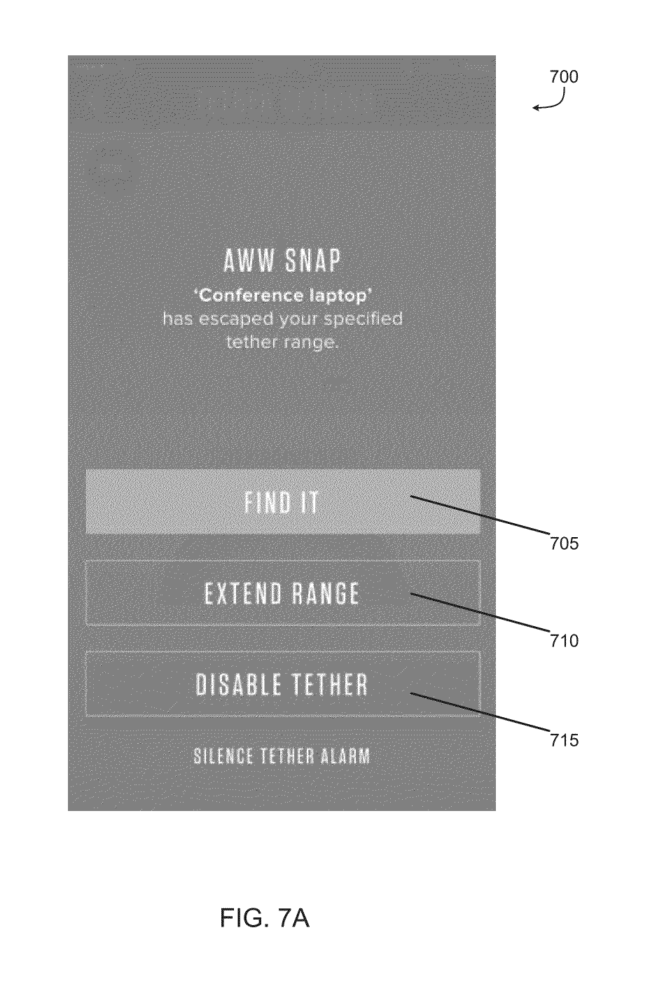

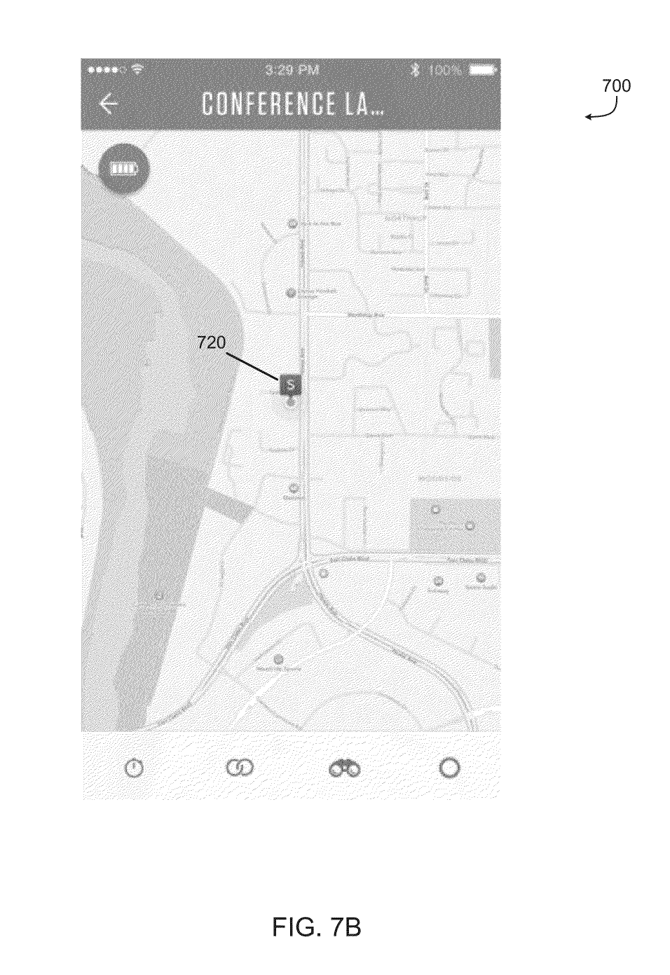

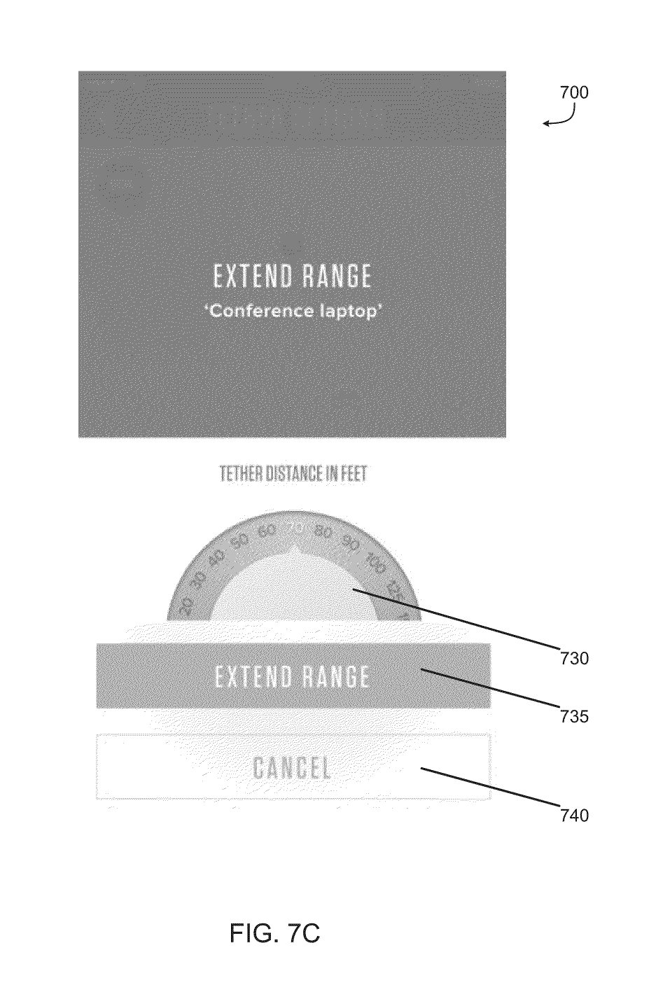

FIGS. 7A-7C show screenshots of alert messages. As shown in FIG. 7A, alert message 700 presents the user with a message that the predetermined threshold distance has been exceeded. Further, alert message 700 presents the user with several responses to the alert message. For example, alert message 700 includes selectable element 705 to present the estimated location of the wireless tracking device, selectable element 710 to extend the threshold distance, and selectable element 715 to turn of alert messages.

FIG. 7B shows a screenshot of alert message 700 as a result of a user selecting selectable element 705 to view of the estimated location of the corresponding wireless tracking device. As shown, the alert message 700 presents the user with a map and includes location indicator 720. Location indicator 720 represents the estimated location of the wireless tracking device.

FIG. 7C shows a screenshot of alert message 700 as a result of a user selecting selectable element 710 to extend the threshold distance. As show, alert message 700 can present the user with adjustable element 730 that enables the user to select an amount to increase the threshold distance. Upon selection of an additional distance using adjustable element 730, the user can select selectable element 735 to confirm the adjustment, thereby causing the change to the set of alert conditions. Alternatively, the user can select selectable element 740 to cancel the adjustment.

FIGS. 8A and 8B illustrate a wireless tracking device. As shown in FIG. 8A, wireless tracking device 800 can be designed to be a small simple device to facilitate attaching the wireless tracking device 800 to items for tracking. Wireless tracking device 800 can include opening 805 to facilitate attaching wireless tracking device 800 to items.

FIG. 8B illustrates an exploded view of wireless tracking device 800. As shown, internal components 810 can be protected by top casing 815 and bottom casing 820. Top casing 815 and bottom casing 820 can create a waterproof seal around internal components 810, thereby protecting internal components 810 from potential water damage. Further, top casing 815 and bottom casing 820 can be covered in a waterproof material, such as rubber.

Bottom casing 820 can include opening 825 which can allow a battery to be inserted and removed from wireless tracking device 800. Covering 830 can be used to seal opening 825.

FIG. 9A, and FIG. 9B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932, module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates a computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that exemplary systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a client device, from a first wireless tracking device, a first wireless communication signal;
determining, by the client device, based on a first signal strength value indicating a measurement of power present in the first wireless communication signal when it was received by the client device, that a set of alert conditions associated with the first wireless tracking device have been satisfied;
presenting, by the client device, an alert message indicating that the set of alert conditions have been satisfied.

2. The method of claim 1, wherein the set of alert conditions dictate a threshold distance and determining that the set of alert conditions have been triggered comprises:
determining, based on the first signal strength value, a first estimated distance of the first wireless tracking device from the client device; and
determining that the first estimated distance exceeds the threshold distance.

3. The method of claim 2, further comprising:
receiving, in response to the alert message, an input message indicating that a first human user has selected to increase the threshold distance; and
modifying the set of alert conditions to increase the threshold distance according to the alert message, yielding an updated set of alert conditions that dictate an updated threshold distance.

4. The method of claim 3, further comprising:
receiving, from the first wireless tracking device, a second wireless communication signal;
determining, based on a second signal strength value indicating a measurement of power present in the second wireless communication signal when it was received by the client device, a second estimated distance of the second wireless tracking device;
determining that the second estimated distance does not exceed the updated threshold distance; and
determining that the updated set of alert conditions associated with the first wireless communication device have not been satisfied.

5. The method of claim 2, wherein the set of alert conditions dictate a specified time period spanning between a start time and an end time, and determining that the set of alert conditions have been triggered comprises:
determining that a time at which the first wireless communication signal was received by the client device falls within the specified time period.

6. The method of claim 5, further comprising:
receiving, from the first wireless tracking device, a second wireless communication signal;
determining that a time at which the second wireless communication signal was received by the client device does not fall within the specified time period; and
determining that the set of alert conditions associated with the first wireless communication device have not been satisfied.

7. The method of claim 2, wherein the set of alert conditions dictate a first geographic location, and determining that the set of alert conditions have been triggered comprises:
determining that a geographic location of the client device is within a predetermined distance of the first geographic location.

8. A client device comprising:
a computer processor; and
a memory containing instructions that, when executed, cause the computer processor to:
receive, from a first wireless tracking device, a first wireless communication signal;
determine, based on a first signal strength value indicating a measurement of power present in the first wireless communication signal when it was received by the client device, that a set of alert conditions associated with the first wireless tracking device have been satisfied;
present an alert message indicating that the set of alert conditions have been satisfied.

9. The client device of claim 8, wherein the set of alert conditions dictate a threshold distance and determining that the set of alert conditions have been triggered comprises:
determining, based on the first signal strength value, a first estimated distance of the first wireless tracking device from the client device; and
determining that the first estimated distance exceeds the threshold distance.

10. The client device of claim 9, wherein the instructions further cause the computer processor to:
receive, in response to the alert message, an input message indicating that a first human user has selected to increase the threshold distance; and
modify the set of alert conditions to increase the threshold distance according to the alert message, yielding an updated set of alert conditions that dictate an updated threshold distance.

11. The client device of claim 10, wherein the instructions further cause the computer processor to:
receive, from the first wireless tracking device, a second wireless communication signal;
determine, based on a second signal strength value indicating a measurement of power present in the second wireless communication signal when it was received by the client device, a second estimated distance of the second wireless tracking device;
determine that the second estimated distance does not exceed the updated threshold distance; and
determine that the updated set of alert conditions associated with the first wireless communication device have not been satisfied.

12. The client device of claim 9, wherein the set of alert conditions dictate a specified time period spanning between a start time and an end time, and determining that the set of alert conditions have been triggered comprises:
determining that a time at which the first wireless communication signal was received by the client device falls within the specified time period.

13. The client device of claim 12, wherein the instructions further cause the computer processor to:
receive, from the first wireless tracking device, a second wireless communication signal;
determine that a time at which the second wireless communication signal was received by the client device does not fall within the specified time period; and
determine that the set of alert conditions associated with the first wireless communication device have not been satisfied.

14. The client device of claim 9, wherein the set of alert conditions dictate a first geographic location, and determining that the set of alert conditions have been triggered comprises:
determining that a geographic location of the client device is within a predetermined distance of the first geographic location.

15. A non-transitory computer-readable medium containing instructions that, when executed by a computer processor of a client device, cause the computer processor to:
receive, from a first wireless tracking device, a first wireless communication signal;
determine, based on a first signal strength value indicating a measurement of power present in the first wireless communication signal when it was received by the client device, that a set of alert conditions associated with the first wireless tracking device have been satisfied;
present an alert message indicating that the set of alert conditions have been satisfied.

16. The non-transitory computer-readable medium of claim 15, wherein the set of alert conditions dictate a threshold distance and determining that the set of alert conditions have been triggered comprises:
determining, based on the first signal strength value, a first estimated distance of the first wireless tracking device from the client device; and
determining that the first estimated distance exceeds the threshold distance.

17. The non-transitory computer-readable medium of claim 16, wherein the instructions further cause the computer processor to:
receive, in response to the alert message, an input message indicating that a first human user has selected to increase the threshold distance; and
modify the set of alert conditions to increase the threshold distance according to the alert message, yielding an updated set of alert conditions that dictate an updated threshold distance.

18. The non-transitory computer-readable medium of claim 17, wherein the instructions further cause the computer processor to:
receive, from the first wireless tracking device, a second wireless communication signal;
determine, based on a second signal strength value indicating a measurement of power present in the second wireless communication signal when it was received by the client device, a second estimated distance of the second wireless tracking device;
determine that the second estimated distance does not exceed the updated threshold distance; and
determine that the updated set of alert conditions associated with the first wireless communication device have not been satisfied.

19. The non-transitory computer-readable medium of claim 16, wherein the set of alert conditions dictate a specified time period spanning between a start time and an end time, and determining that the set of alert conditions have been triggered comprises:
determining that a time at which the first wireless communication signal was received by the client device falls within the specified time period.

20. The non-transitory computer-readable medium of claim 19, wherein the instructions further cause the computer processor to:
receive, from the first wireless tracking device, a second wireless communication signal;
determine that a time at which the second wireless communication signal was received by the client device does not fall within the specified time period; and
determine that the set of alert conditions associated with the first wireless communication device have not been satisfied.

21. The non-transitory computer-readable medium of claim 16, wherein the set of alert conditions dictate a first geographic location, and determining that the set of alert conditions have been triggered comprises:
determining that a geographic location of the client device is within a predetermined distance of the first geographic location.
